(19) United States
(12) Patent Application Publication
(10) Pub. No.: US 2007/0116428 A1
(43) Pub. Date: May 24, 2007

(54) Video display apparatus and method for storing and reproducing broadcasting program

(75) Inventor: Eun Hae Choi, Gangreung-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/590,919

(22) Filed: Nov. 1, 2006

Related U.S. Application Data
(63) Continuation-in-part of application No. 11/445,133, filed on Jun. 2, 2006.

(30) Foreign Application Priority Data
Jun. 3, 2005 (KR) 10-2005-0047684

(51) Int. Cl. H04N 5/445; H04N 5/91

(52) U.S. Cl. 386/83; 725/38

(57) ABSTRACT

A method is provided for reproducing a broadcasting program that includes setting a channel for the broadcasting program, and storing the broadcasting program in a storage medium. The stored broadcasting program may be reproduced when switching to the set channel. Other embodiments may also be provided.

The present application is a Continuation-In-Part application of U.S. application Ser. No. 11/445,133, filed Jun. 2, 2006, which in turn claims priority from Korean Application No. 47684/2005, filed Jun. 3, 2005, the subject matters of which are incorporated herein by reference.

### BACKGROUND

1. Field

Embodiments of the present invention may relate to a method for reproducing a broadcasting program and to a video display apparatus.

2. Background

As a digital television standard called advanced television (ATV) is adopted in the United States and a digital television standard such as high definition (HD)-digital video narrow-band emission (DIVINE), SPECTRE, DIAMOND, etc. is adopted in Europe, a variety of research on digital television technologies are in active progress.

In digital television broadcasting, a data stream may be transmitted together with video and audio streams. The data stream may contain java-based data information such as hyper text markup language (HTML) of advance television enhancement forum (ATVEF), and XLET of Digital TV Application Software Environment (DASE). The data stream may include electronic program guide (EPG) data. The EPG data (or EPG information) may include program guide information regarding broadcasting programs.

The EPG information may provide guidance regarding broadcasting programs to a user and may be used for various purposes. For example, the EPG information may be used for detecting an error in reservation recording conditions input by a user using the EPG, and automatically changing the reservation recording conditions according to the EPG when an error is detected in the reservation recording conditions. The EPG information may automatically correct a reservation error caused by a user's mistake or change of broadcasting program to allow a user's desired program to be normally recorded.

However, reservation recording may merely perform reservation recording according to a user's reservation recording command. Therefore, when a user performs the reservation recording on a plurality of programs and intends to reproduce a predetermined program, a user may have an inconvenience of exploring a relevant program contained in a recording list and reproducing the explored program.

Additionally, when the predetermined program is a program such as a serial drama that includes a plurality of episodes broadcast one episode at a time every predetermined period, then a user may explore and reproduce one of the episodes, and then later explore and reproduce another episode. This may increase user inconvenience.

Development of a technology that allows a user to selectively reproduce some of a plurality of reservation-recorded programs with only simple manipulation may be desired.

Additionally, technology that allows a user to reproduce some episodes of a program with only simple manipulation even when the program includes a plurality of episodes broadcast one episode at a time every predetermined period may be highly desired.

### BRIEF DESCRIPTION OF THE DRAWINGS

Embodiments of the present invention may be described with reference to the following drawings in which like reference numerals refer to like elements and wherein:

FIG. 1 is a block diagram of a video display apparatus according to an example embodiment of the present invention;

FIG. 2 is a view illustrating a program reservation table according to an example embodiment of the present invention;

FIG. 3 is a program recording table according to an example embodiment of the present invention;

FIGS. 4 to 7 are flowcharts illustrating methods for recording and reproducing programs according to example embodiments of the present invention;

FIG. 8 shows an electronic program guide (EPG) according to an example embodiment of the present invention; and

FIG. 9 shows a virtual channel display according to an example embodiment of the present invention.

### DETAILED DESCRIPTION

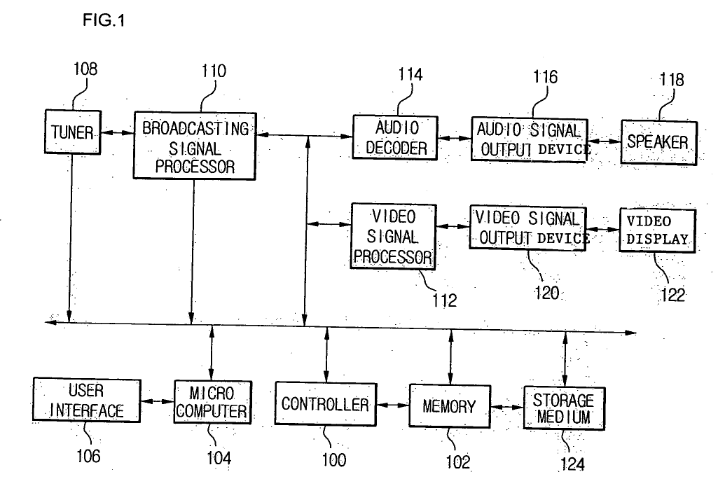

A video display apparatus according to an example embodiment of the present invention will be described with reference to FIG. 1. More specifically, FIG. 1 is a block diagram of a video display apparatus according to an example embodiment of the present invention. Other embodiments and configurations are also within the scope of embodiments of the present invention. As shown, the video display apparatus may include a controller 100, a memory 102, a microcomputer 104 (or processor), a user interface 106 and a storage medium 124.

The controller 100 may control overall operations of the video display apparatus, and record and reproduce a broadcasting program.

A memory 102 may store a variety of information including a processing program of the controller 100. The memory 102 may also store a program reservation table and a program recording table.

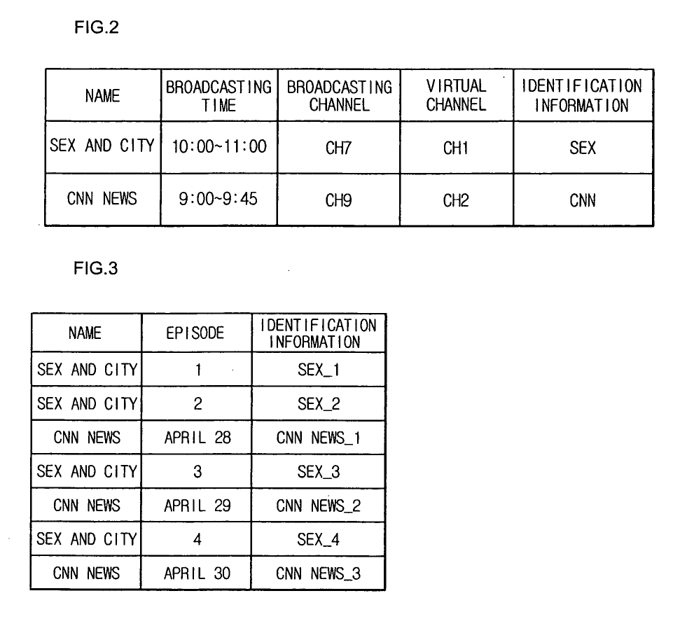

FIG. 2 is a view illustrating a program reservation table according to an example embodiment of the present invention. Other embodiments and configurations are also within the scope of embodiments of the present invention. More specifically, FIG. 2 shows that the program reservation table may contain program reservation information including a broadcasting time, a broadcasting channel, a virtual channel and program identification information of a program that a user has selected for reservation recording. For example, FIG. 2 shows that a broadcasting time of a program titled “Sex and City” is 10:00-11:00, a broadcasting channel thereof is CH7, a virtual channel thereof is CH1 (or VCH1) and a program identification information thereof is “SEX”. A broadcasting time for a program titled “CNN News” is 9:00-9:45, a broadcasting channel thereof is CH9, a virtual channel thereof is CH2 (or VCH2) and a program identification information thereof is “CNN.”

The broadcasting time and the broadcasting channel may be directly input by a user or may be automatically input when a program is selected through a program guide such as an electronic program guide (EPG). The virtual channel may be directly input by a user based on a user's preference, or an invalid channel may be arbitrarily set for a virtual channel by the controller 100. The virtual channel is intended to be used for reproducing a recorded program. The virtual channel (or the invalid channel) may be a channel that is not used for broadcasting programs in real time. The virtual channel may correspond to a channel for reproducing previously-stored programs.

The program identification information may be arbitrarily set by the controller 100. The program identification information may be used as a folder name or a direct name of the storage medium 124. That is, the controller 100 may create a folder or a directory associated with the identification information of the program at the storage medium 124 when reservation information of the program is registered.

Although the memory 102 and the storage medium 124 are shown in FIG. 1 as being separately provided, the memory 102 and the storage medium 124 may be provided in a single storage space. Additionally, the memory 102 and/or the storage medium 124 may be a built-in memory. Otherwise, the memory 102 and/or the storage medium 124 may be provided as external devices that can be electrically connected to the video display apparatus. In this case, the video display apparatus may be a connection terminal(s) for connecting to an external storage medium(s).

FIG. 3 is a program recording table according to an example embodiment of the present invention. Other embodiments and configurations are also within the scope of embodiments of the present invention. More specifically, the program recording table may store program recording information including episode numbers and identification information of a recorded program. For example, episode 1 of the program “Sex and City” may include an identification information of “SEX_{—1}” where the identification information “SEX” and the episode number information “1” representing a first recorded program are combined. The episode number information may correspond to a specific episode number of a program or may correspond to an order of the recorded episodes in the memory 102 (or the storage medium 124).

The identification information of the recorded program may be pre-established and/or arbitrarily determined by the controller 100. The identification information of the recorded program may be used as a filename stored in the storage medium 124. That is, the controller 100 may store the program in the storage medium 124 using the identification information of the recorded program for a filename.

The microcomputer 104 may provide various commands or information from a user through the user interface 106 to the controller 100.

The user interface 106 may receive various commands or information from a user using a keypad or a remote controller. The user interface 106 may provide the received commands or information to the microcomputer 104.

The tuner 108 may select broadcasting signals of a predetermined channel from broadcasting signals, and provide the selected broadcasting signals to the broadcasting signal processor 110 under control of the controller 100. The broadcasting signal processor 110 may include a transport stream (TS) decoder and may recover the broadcasting signals to the TS. The broadcasting signal processor 110 may separate the TS into audio streams, video streams and data streams.

FIG. 1 also shows that the video display apparatus may include a tuner 108, the broadcasting signal processor 110, a video signal processor 112, an audio decoder 114, an audio signal output device 116, a speaker 118, a video signal output device 120 and a video display 122.

The video stream may be processed by the video signal processor 112 into signals that can be output and displayed by the video display 122 via the video signal output device 120. The video signal output device 120 may receive on-screen-display (OSD) data and output the OSD data to the video display 122 (e.g., TV, monitor, LCD, PDP, OLED, CRT, etc.) under control of the controller 100.

The broadcasting signal processor 110 may provide the audio stream to the audio decoder 114 that recovers the audio stream to audio data and outputs the recovered audio data to the speaker 118 via the audio signal output device 116. The speaker 118 may be integrally formed with the video display apparatus. The speaker 118 may also be provided as an external device that can be electrically connected to the video display apparatus.

The broadcasting signal processor 110 may provide the data stream to the controller 100. The data stream may contain EPG data used for forming a program guide.

The storage medium 124 may be a large-capacity storage medium to store video and audio streams of a program under control of the controller 100. The storage medium 124 may provide folder storing identification information of a program. A program containing corresponding identification information may be stored in a corresponding folder, and a filename of the program may be determined by identification information of the recorded program.

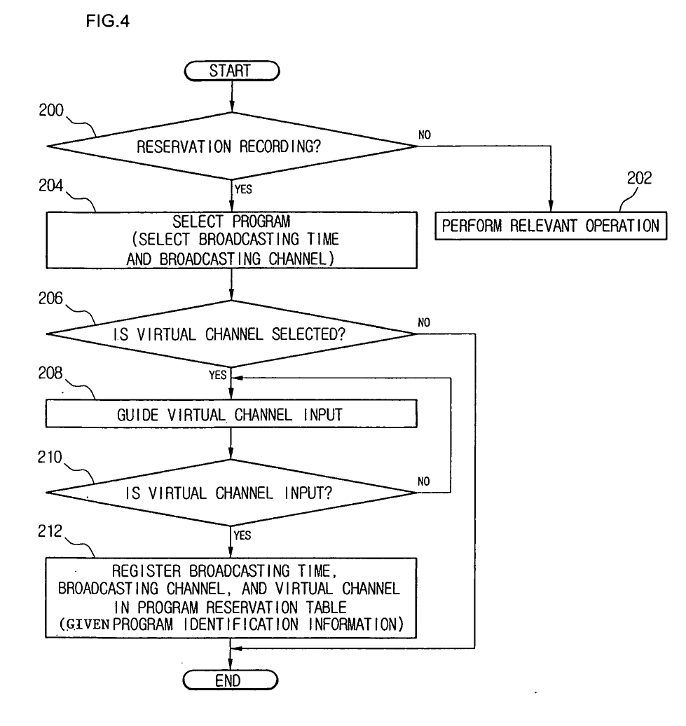

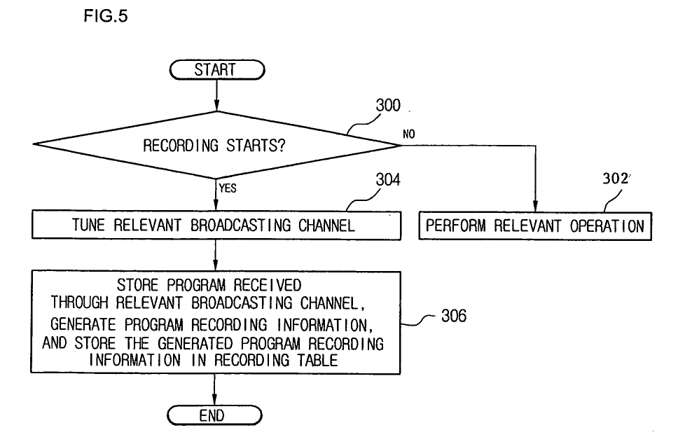

A process of performing reservation recording of a program will now be described with reference to FIG. 4. FIG. 4 is a flowchart illustrating a method for recording and reproducing a program according to an example embodiment of the present invention. Other operations, orders of operations and embodiments are also within the scope of embodiments of the present invention.

When a user requests reservation recording through the user interface 106 (operation 200), the controller 100 may guide a user so that the user may select a program from a program guide or a broadcasting time and a broadcasting channel (operation 204). When a user does not request reservation recording, normal (or relevant) operations of the video display apparatus may be performed in operation 202.

A user may select a program (or a broadcasting time and a broadcasting channel) based on guidance of the controller 100. In operation 206, the controller 100 may question a user regarding setting (or selecting) of a virtual channel to be used when reproducing a program (i.e., displaying a previously-recorded program). The questioning may be displayed through an on-screen-display (OSD). When a user requests the setting of the virtual channel through the user interface 106, the controller 100 may guide inputting of the virtual channel (operations 206 and 208).

A user may input a desired virtual channel using the user interface 106 based on the guidance (operation 210). The controller 100 may register the input virtual channel, the broadcasting time, the broadcasting channel, and/or the virtual channel as program reservation information in the program reservation table (operation 212). The controller 100 may provide program identification information corresponding to the program reservation information.

The broadcasting time, the broadcasting channel, the virtual channel, and/or the program identification information regarding a program for which reservation recording has been requested by a user may be registered as the program reservation information in the program reservation table. The controller 100 may automatically create a folder or a directory corresponding to the identification information in the storage medium 124.

Although the setting (or selecting) of the virtual channel according to a user's request is described above, the controller 100 may guide a user so that a user inputs another channel when the selected channel is a broadcast channel (for a direct broadcast of a program) or has already been set as a virtual channel for another program. When another channel is input based on guidance of the controller 100, then the channel can be set as a virtual channel of a program for which reservation recording has been requested.

A process for recording a program according to the program reservation information will now be described with reference to FIG. 5. FIG. 5 is a flowchart illustrating a method for recording and reproducing a program according to an example embodiment of the present invention. Other operations, orders of operations and embodiments are also within the scope of embodiments of the present invention.

In operation 300, the controller 100 may check whether a current time point counted by an internal timer or a current time point received through the broadcasting signals corresponds to a program broadcasting start time point contained in the program reservation information.

When the current time point corresponds to the program broadcasting start time point contained in the program reservation information, the controller 100 may control the tuner 108 in operation 304 to select a broadcasting channel according to the corresponding program broadcasting information. Video, audio and/or data streams of a corresponding program may be received through a broadcasting channel according to the corresponding program broadcasting information.

When the video, audio and/or data streams are received, the controller 100 may check whether the program is stored as a file in a folder indicated by identification information of the corresponding program and provided to the storage medium 124. When a file for the program is absent, the controller 100 may provide episode number information “1” to the program identification information to create identification information of a recorded program, and store the video and audio streams of the program in a folder of the storage medium 124 that is indicated by the identification information of the corresponding program using the created identification information of the recorded program for a filename.

When the file for the program is present in the folder, the controller 100 may provide a value obtained by adding “1” to the number of files stored in the folder as episode number identification information so as to create identification information of a recorded program, and video and audio streams of the program may be stored in a folder of the storage medium 124 that is indicated by the identification information of the corresponding program using the created identification information of the recorded program as the filename.

The controller 100 may extract program guide information corresponding to a broadcasting time and a broadcasting channel, episode number information and/or broadcasting date information of the received program from the extracted program guide information so as to create program recording information together with the identification information of the recorded program, and store the program recording information in a program recording table.

Accordingly, the storage medium 124 may have a folder for each program and the storage medium 124 may store corresponding programs in respective folders so that programs corresponding to relevant virtual channels can be easily explored when switching to corresponding virtual channels.

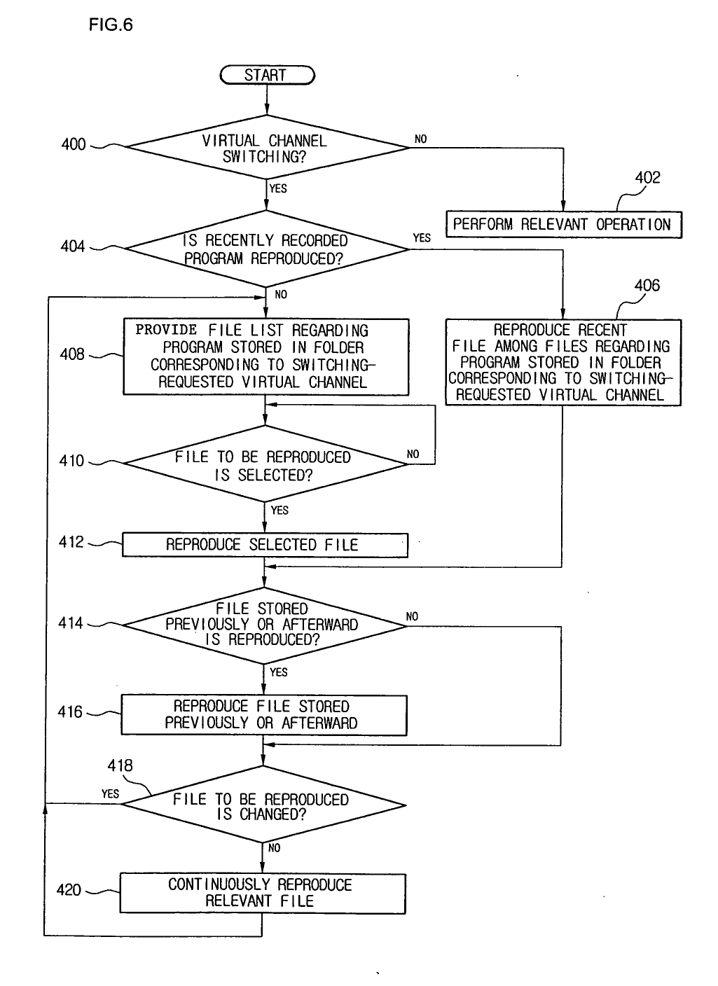

A method for reproducing a stored broadcasting program when switching to a virtual channel will now be described with reference to FIG. 6. More specifically, FIG. 6 is a flowchart illustrating a method for recording and reproducing a program according to an example embodiment of the present invention. Other operations, orders of operations and embodiments are also within the scope of embodiments of the present invention.

When a user provides a command for switching to a virtual channel through the user interface 106 (operation 400), the controller 100 may display a guidance OSD questioning a user regarding whether to reproduce a recently recorded program among programs corresponding to a relevant virtual channel. When the user does not provide the command for switching to the virtual channel, then normal (and relevant) operations may be performed in operation 402.

When a user selects to reproduce the recently recorded program through the user interface 106 according to the guidance OSD (i.e., YES branch from operation 404), then the controller 100 may extract and reproduce a file of a program stored in the folder of the storage medium 124 that corresponds to the switching-requested virtual channel having a largest identifier of the file or a most recent storage date (operation 406), for example.

On the other hand, when a user does not select to reproduce a recently recorded program (i.e., NO branch from operation 404), then the controller 100 may display the guidance OSD for providing a list regarding files of programs stored in a folder of the storage medium 124 that corresponds to the switching-requested virtual channel (operation 408). The list may include different episodes of a specific program, for example.

When a user selects one of the files contained in the list through the user interface 106 in operation 410, the controller 100 may reproduce the selected file (operation 412). The selected file may be reproduced on the specific virtual channel.

When a user requests reproduction of a file stored before or after a currently reproduced file through the user interface 106 (i.e., YES branch in operation 414), the controller 100 may reproduce the file stored before or after the currently reproduced file (operation 416).

When a user requests change of a file to be reproduced through the user interface 106 during the reproduction of a current file (operation 418), the controller 100 may perform operation 408 to provide the list regarding files of the programs stored in the folder that correspond to the virtual channel and to reproduce a file selected by a user.

Although a process for selecting whether to reproduce a recently recorded file (broadcasting program) when switching to the virtual channel is described, the recently recorded program may also be automatically reproduced by a user's switching to the corresponding virtual channel. For example, when a user switches to a virtual channel, a recorded program that has been stored and associated with that particular virtual channel may be automatically reproduced on a display. Using the program reservation table in FIG. 2 as one example, when a user switches to virtual channel CH1, then the recorded program of “Sex and City” may be automatically displayed on the virtual channel CH1. If the user subsequently changes the channel such as to the broadcasting channel CH9, then information regarding a stopping point of “Sex and City” may be stored so that “Sex and City” may be later displayed beginning from the stopping point when the user again changes to the virtual channel CH1 (and/or issues a command for further displaying). Alternatively, the entire episode of “Sex and City” may be displayed from a beginning point when the user again changes to the virtual channel.

As another example, when a user changes to a virtual channel, a menu or listing may be displayed to allow a user to select one of a plurality of episodes of a program associated with the virtual channel. This allows the user to watch any one of the programs and/or episodes associated with a virtual channel.

As a further example, when a user changes to a virtual channel, a menu may be displayed allowing a selection of various features (such as a starting point) related to the stored program.

Additionally, while the above description relates to a user selecting a broadcasting program to be recorded, programs stored in a corresponding virtual channel may be reproduced without a user's separate manipulation of sequentially reproducing the programs according to recording dates.

Although the above description relates to the virtual channel being set when recording reservation of a program is performed, the virtual channel may be set or changed after reservation recording of the program is completed. The changed information may be stored.

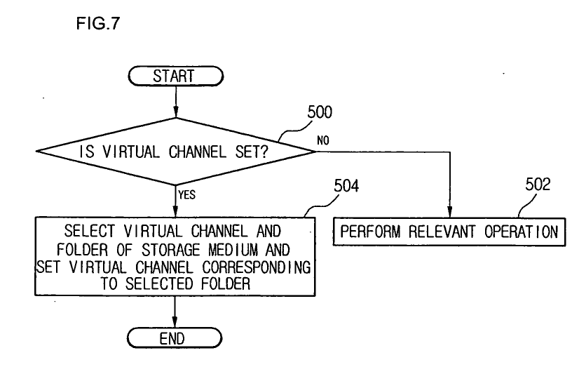

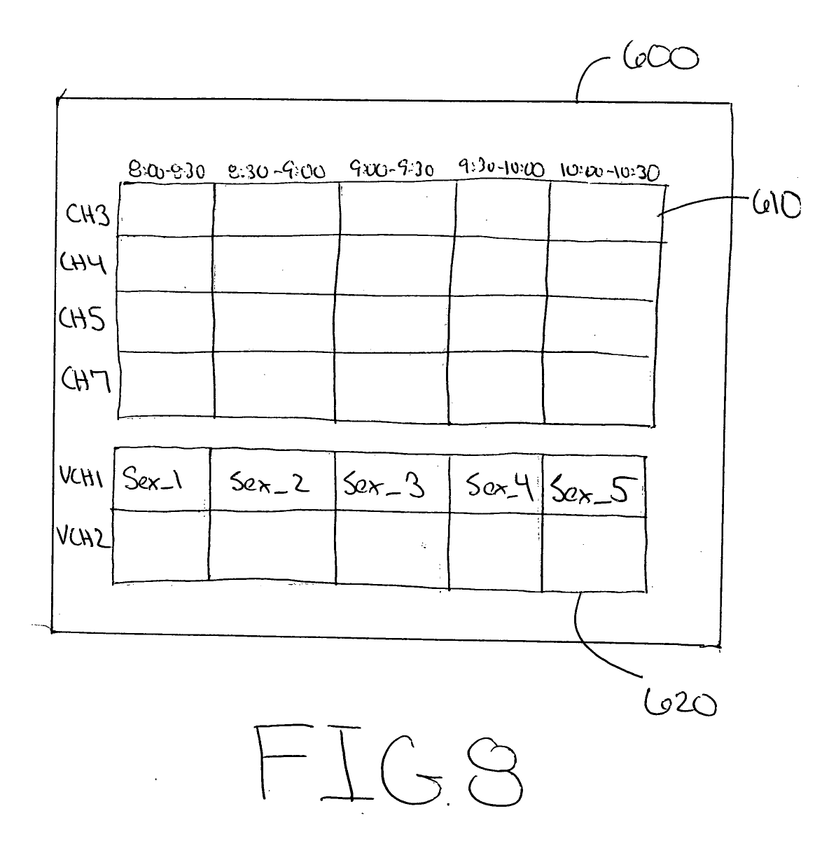

A method for setting the virtual channel will now be described with reference to FIG. 7. More specifically, FIG. 7 is a flowchart illustrating a method for recording and reproducing a program according to an example embodiment of the present invention. Other operations, orders of operations and embodiments are also within the scope of embodiments of the present invention.

When a user requests setting of the virtual channel through the user interface 106 (operation 500), the controller 100 provides a list regarding folders provided to the storage medium 124, and guides a user so that the user may input a virtual channel. The folder may be provided for each program or each kind of program.

When a user selects the folder provided to the storage medium 124 and inputs the virtual channel based on guidance of the controller 100, the controller 100 may set a virtual channel corresponding to the folder. Virtual channel setting information is registered in the program reservation information.

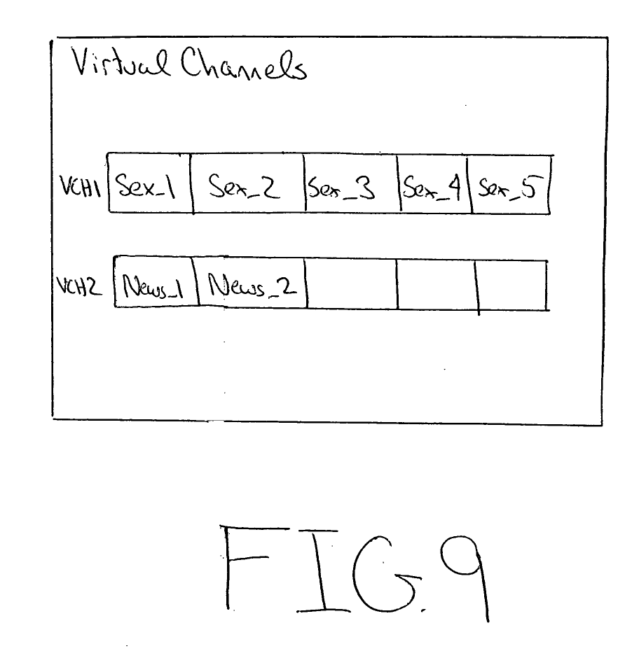

FIG. 8 shows an electronic program guide (EPG) according to an example embodiment of the present invention. Other embodiments and configurations are also within the scope of embodiments of the present invention. More specifically, FIG. 8 shows an EPG 600 that may be displayed on a specific channel or may be displayed based on a user selecting to display the EPG 600 (such as by pressing a button or issuing a command). The EPG 600 may be in the form of a grid-like matrix such as having various times along one axis (e.g., the horizontal axis) and channels listed along the other axis (e.g., the vertical axis). For ease of display and description, FIG. 8 does not show information within the grid-like matrix other than information associated with virtual channel VCH1.

The channels along the vertical axis may include broadcast channels (CH3, CH4, CH5 and CH7) and virtual channels (VCH1, VCH2). Other channel numbers may also be displayed. The virtual channels may correspond to channels selected by a user (or by the system) so as to display pre-recorded episodes and/or programs.

A broadcast channel section 610 may include information such as program names for displaying on broadcast channels in real time. A virtual channel section 620 may include information for providing previously recorded (or to-be-recorded) programs on virtual channels.

If a plurality of episodes for one program have been recorded (or will be recorded) with respect to one virtual channel, then information regarding the plurality of episodes (or only a few of the episodes) associated with that virtual channel may be displayed in the virtual channel section 620. For example, FIG. 8 shows five episodes of “Sex and City” that are associated with virtual channel VCH1. These five episodes are “Sex_{—1},” “Sex_{—2},” “Sex_{—3},” “Sex_{—4}” and “Sex_{—5}.” Other information regarding these episodes may also be displayed.

In at least one embodiment, if a user were to turn to virtual channel VCH1 at 8:15 p.m., for example, then the episode associated with “Sex_{—1}” may be displayed either from a beginning of the episode, from a previously stopped viewing point of “Sex_{—1}” or from a viewing point fifteen minutes from the beginning of “Sex_{—1}.” The user may be provided with an option of which point to start from in an OSD. The episode may also be automatically displayed.

The EPG 600 therefore displays program information and/or episode information relating to programs and/or episodes that have been stored or will be stored for each virtual channel. Information associated with the EPG 600 may also include information regarding when a specific program and/or episode has been recorded (or will be recorded).

FIG. 9 shows a virtual channel display according to an example embodiment of the present invention. Other embodiments and configurations are also within the scope of embodiments of the present invention. More specifically, FIG. 9 shows a virtual channel display that may be accessed by a user based on a specific user command or may be accessed through the EPG. The display shown in FIG. 9 may include specific information regarding the virtual channels. For example, FIG. 9 shows that five episodes of “Sex and City” may be associated with virtual channel VCH1. Each of the respective episodes may be viewed by moving a cursor and/or other type of selecting device so as to select one of the specific episodes shown in the virtual channel display for virtual channel VCH1. Additionally, the virtual channel display shown in FIG. 9 also shows that two different news episodes (or shows) may be provided for news such as “CNN News.” “News_{—1}” and “News_{—2}” may correspond to different shows of a news program (i.e., different episodes). Various episodes and/or programs shown in the virtual channel display may be accessed in any number of ways such as by scrolling and/or issuing commands. Additional information for the displayed programs and/or episodes may also be provided by issuing specific commands.

Embodiments of the present invention allow a user to select (or assign) programs and/or episodes to a plurality of different virtual channels.

An example embodiment of the present invention may include a computer-readable recording medium that contains program commands for performing operations on a variety of computers. The computer-readable recording medium may include program commands, data files, data structures, and/or a combination thereof. The program commands of the computer-readable recording medium may be particularly designed and prepared for example embodiments of the present invention, or may be known to those skilled in the art.

Computer-readable recording mediums may include hard disks (HDs), magnetic media such as floppy disks (FDs) and magnetic tapes, optical media such as compact disc (CD)-read only memories (ROMs) and digital versatile discs (DVDs), magneto-optical media such as optical disks, ROMs, RAMs, and flash memories. A hardware apparatus may also be provided that is particularly configured to store and perform the program commands.

The recording medium may be connected to an optical line, a metal line, and/or a waveguide transmitting carrier waves containing signals that designate program commands, and data structures. The program commands may include not only machine language codes created by a compiler but also high-level language that can be executed by a computer using an interpreter.

Embodiments of the present invention may selectively reproduce some of a plurality of reservation-recorded programs with only simple manipulation of channel switching.

Additionally, different virtual channels may be provided to programs including a plurality of episodes broadcasted by one episode every predetermined period, and the recorded programs corresponding to the virtual channels may be reproduced with only a user's request for switching to one of the virtual channels.

Embodiments of the present invention may be directed to a video display apparatus and a method for storing and reproducing a broadcasting program.

Embodiments of the present invention may provide a method and apparatus for recording and reproducing a program capable of selectively reproducing a plurality of reservation-recorded programs with simple manipulation such as channel switching.

Embodiments of the present invention may provide a method and apparatus for recording and reproducing a program capable of giving different virtual channels to programs including a plurality of episodes broadcasted by one episode every predetermined period, and reproducing a recorded program through a corresponding virtual channel by only requesting switching to the relevant virtual channel of the plurality of virtual channels.

Embodiments of the present invention may provide a method for reproducing a broadcasting program. The method may include setting a channel for a broadcasting program, storing the broadcasting program in a storage medium, and reproducing the stored broadcasting program when switching to the set channel.

Embodiments of the present invention may provide a method for storing a broadcasting program that includes setting recording of the broadcasting program including a plurality of episodes broadcasted in a series, setting identification information of the broadcasting program, and storing the broadcasting program in a folder of a storage medium with reference to the identification information.

Embodiments of the present invention may also provide a video display apparatus that includes a tuner, a broadcasting signal processor, a display unit and a controller. The tuner may receive a broadcasting program. The broadcasting signal processor may recover the broadcasting program and separate the recovered broadcasting program into video and audio streams. The video and audio processors may process the video and audio streams into video and audio signals, respectively. The display unit may display the video signal. The user interface may receive a user's command. The controller may record the broadcasting program in a recording medium according to a signal from the user interface. The controller may further set a channel for the broadcasting program, and reproduce the broadcasting program associated with the set channel when switching to the set channel.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A method for reproducing a program having at least one of a video signal, an audio signal or a data signal, the method comprising:
receiving the program associated with a first channel;
storing the at least one of the video signal, the audio signal or the data signal in a storage medium or a storage device;
retrieving the at least one of the video signal, the audio signal or the data signal; and
providing the at least one of the video signal, the audio signal or the data signal using a second channel, wherein the first and second channels are different channels.

2. The method according to claim 1, wherein the second channel comprises a user selected channel.

3. The method according to claim 2, further comprising storing information regarding the user selected channel.

4. The method according to claim 3, wherein storing the information comprises storing the information as program reservation information.

5. The method according to claim 1, wherein storing the at least one of the video signal, the audio signal or the data signal includes storing a plurality of episodes in a same folder of the storage medium or the storage device.

6. The method according to claim 5, wherein retrieving the at least one of the video signal, the audio signal or the data signal includes selecting a recently stored episode among the plurality of episodes stored in the same folder.

7. The method according to claim 6, wherein providing the at least one of the video signal, the audio signal or the data signal includes:
providing an episode stored before or after a currently provided episode among the plurality of episodes stored in the same folder when a command is input for providing the episode stored before or after the currently provided episode among the plurality of episodes.

8. The method according to claim 1, wherein the second channel comprises an arbitrarily set channel.

9. The method according to claim 1, wherein the program is reservation-recorded by inputting a broadcasting time and a broadcasting channel.

10. The method according to claim 1, wherein the program is reservation-recorded with reference to an electronic program guide (EPG).

11. The method according to claim 1, wherein the second channel comprises a channel through which a broadcasting program is not transmitted.

12. The method according to claim 1, wherein a first prescribed number of channels are used to receive programs and a second prescribed number of channels are used to display programs.

13. The method according to claim 1, wherein the second channel is pre-assigned from at least three unique channels.

14. The method according to claim 1, wherein the second channel comprises a pre-assigned channel for reproducing the recorded program.

15. The method according to claim 1, wherein storing the at least one of the video signal, the audio signal or the data signal includes selecting the second channel and storing information regarding the selected second channel along with information regarding the at least one of the video signal, the audio signal or the data signal.

16. The method according to claim 1, further comprising the user selecting the second channel after the user selects another channel to provide the at least one of the video signal, the audio signal or the data signal and being informed that the another channel is a channel for broadcast or the another channel has already been selected as the second channel.

17. A method for reproducing a program having at least one of a video signal, an audio signal or a data signal, the method comprising:
receiving a first program associated with a first channel;
storing the first program in a storage medium or a storage device;
receiving a second program associated with the first channel or another channel;
storing the second program in the storage medium or the storage device; and
providing the first program on a second channel and providing the second program on a third channel, wherein the first, second and third channels are different channels.

18. The method according to claim 17, wherein the second channel comprises a user selected channel.

19. The method according to claim 18, further comprising storing information regarding the user selected channel.

20. The method according to claim 19, wherein storing the information comprises storing the information as program reservation information.

21. The method according to claim 17, wherein storing the first program includes storing a plurality of episodes in a same folder of the storage medium or the storage device.

22. The method according to claim 17, wherein a first prescribed number of channels are used to receive programs and a second prescribed number of channels are used to display programs.

23. The method according to claim 17, wherein storing the first program includes selecting the second channel and storing information regarding the selected second channel along with the first program.

24. The method according to claim 17, wherein providing the first program includes automatically providing the first program when a user changes to the second channel.

25. The method according to claim 17, wherein providing the first program includes providing information regarding displaying the first program when a user changes to the second channel.

26. A method for storing a program comprising:
storing a plurality of programs, wherein each program includes a plurality of episodes;
setting recording of one of the programs including the plurality of episodes in a series;
setting identification information of the one of the programs; and
storing the one of the programs in a folder of a storage medium or a storage device with reference to the identification information.

27. The method according to claim 26, wherein the identification information represents identification information and episode information of the one of the programs.

28. The method according to claim 26, further comprising:
receiving the plurality of programs associated with a first channel;
retrieving the one of the programs; and
providing the one of the programs using a second channel, wherein the first and second channels are different channels.

29. The method according to claim 28, wherein the second channel comprises a user selected channel.

30. The method according to claim 28, wherein the second channel is a channel through which a broadcasting program is not transmitted.

31. The method according to claim 26, wherein a first prescribed number of channels are used to receive programs and a second prescribed number of channels are used to display programs.

32. The method according to claim 26, wherein the identification information includes episode number information.

33. A method for storing episodes, each episode having at least one of video signal, a data signal or an audio signal, the method comprising:
storing a plurality of first episodes, wherein the first episode is stored based on a first identification information; and
storing a plurality of second episodes, wherein each second episode is stored based on second identification information, wherein the first identification information allows grouping of the second episodes with the first episode, and wherein each group of episodes is linked to a unique channel.

34. The method according to claim 33, wherein the second identification information corresponds to episode number information.
